(19) United States
(12) Patent Application Publication
(10) Pub. No.: US 2012/0012413 A1
(43) Pub. Date: Jan. 19, 2012

(54) Light-duty vehicle with adjustable wheelbase

(75) Inventors: Kun-Lung Tsai, Taichung City (TW); Wei-Jean Huang, Taichung City (TW); Shen-Fu Huang, Taichung City (TW); Yu-Che Huang, Taichung City (TW)

(73) Assignee: Cycling & Health Tech Industry R & D Center

(21) Appl. No.: 12/804,198

(22) Filed: Jul. 16, 2010

(51) Int. Cl. B62D 21/14

(52) U.S. Cl. 180/209

(57) ABSTRACT

A light-duty vehicle with an adjustable wheelbase includes a linkage assembly composed of at least one main rod, a movable support, at least one movable rod and at least one adjusting rod, at least one power source connected in the linkage assembly, a seat mounted on a connecting rod having one end pivotally connected to the movable rod, and a driving wheel set composed of at least one front wheel and at least one rear wheel. The rear wheel is rotatably connected to the adjusting rod, while an opposite end of the main rod is connected to a fixed rod, which is coupled to a front fork above the front wheel. Thereby, when the power source modifies the linkage assembly in posture, the wheelbase between the front wheel and the rear wheel is changed so that the seat is adjusted in posture and altitude.

### BACKGROUND OF THE INVENTION

1. Technical Field

The present invention relates to light-duty vehicles, and more particularly, to a light-duty vehicle whose wheelbase is adjustable so as to allow adjustment of a seat on the vehicle for accommodating a bicyclist in a sitting or recumbent posture.

2. Description of Related Art

For enriching the practicability and value of light-duty vehicles, manufactures have based on the traditional bicycles to develop recumbent tricycles that give enhanced riding safety and comfort. Such an exiting recumbent tricycle is composed of a frame installed with three wheel, namely one front wheel and two rear wheels, a transmission system and a seat, wherein the seat is rearward inclined so that a rider is allowed to ride the recumbent tricycle in a recumbent, relaxed body posture.

Although recumbent tricycles contribute to relaxed, comfortable riding experience by less causing physical fatigue and sour muscle to their riders, it is known that a human body is much more reactive in a sitting riding posture than in a recumbent posture. Therefore, sitting riding is appropriate for short-distance or tough riding routes while for long-distance or easy riding routes, recumbent riding would be the more suitable.

However, there is not any existing light-duty vehicle, no matter it is a bicycle, a recumbent bike or a tricycle as described above, can be self-contained in supporting different riding modes. Hence, it would be desired to have a light-duty vehicle with an adjustable wheelbase so as to allow adjustment of a seat and thereby to allow its rider to optionally ride in a sitting or recumbent posture.

### SUMMARY OF THE INVENTION

In view of the shortcomings of the existing devices and the foregoing desire, the present invention herein provides a light-duty vehicle with an adjustable wheelbase.

According to the present invention, the light-duty vehicle with the adjustable wheelbase comprises a linkage assembly having at least one main rod, a movable support having one end pivotally connected to an end of the main rod and having an opposite end formed with a first pivotal portion, at least one movable rod having one end pivotally connected to a middle portion of the main rod and having an opposite end formed with a second pivotal portion, and at least one adjusting rod pivotally connected between the first pivotal portion and the second pivotal portion; at least one power source connected between the main rod and the second pivotal portion; a seat having therebeneath at least one connecting rod, which has one end coupled to the second pivotal portion through; and a driving wheel set including at least one front wheel and at least one rear wheel between which the wheelbase is defined, wherein the rear wheel is rotatably connected to one end of the adjusting rod, while an opposite end of the main rod is connected to a fixed rod, which is coupled to a front fork above the front wheel, whereby operation of the power source moves the main rod and the second pivotal portion and in turn changes a position of the linkage assembly, so as to modify the wheelbase in length and the seat in altitude and posture.

One objective of the present invention is to provide the above-disclosed light-duty vehicle, wherein the linkage assembly can be controlled by the power source to in turn change the wheelbase between the front wheel and the rear wheel, and consequently to adjust the seat in posture and altitude.

Another objective of the present invention is to provide the above-disclosed light-duty vehicle, wherein a moveable joint is provided on the fixed rod opposite to the front fork for receiving a handle support, and an angle shifting rod is pivotally connected between the handle support and the movable rod, so that a handle on the handle support can be adjusted in position corresponding to the seat.

Another objective of the present invention is to provide the above-disclosed light-duty vehicle, wherein a motor device is provided on the front wheel so that the vehicle is electrically drivable.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is an exploded view of a light-duty vehicle disclosed by the present invention;

FIG. 2 is a partial exploded view of the light-duty vehicle of the present invention;

FIG. 3 is a perspective view of the light-duty vehicle of the present invention; and

FIG. 4 and FIG. 5 illustrate different operational modes of the light-duty vehicle of the present invention.

### DETAILED DESCRIPTION OF THE INVENTION

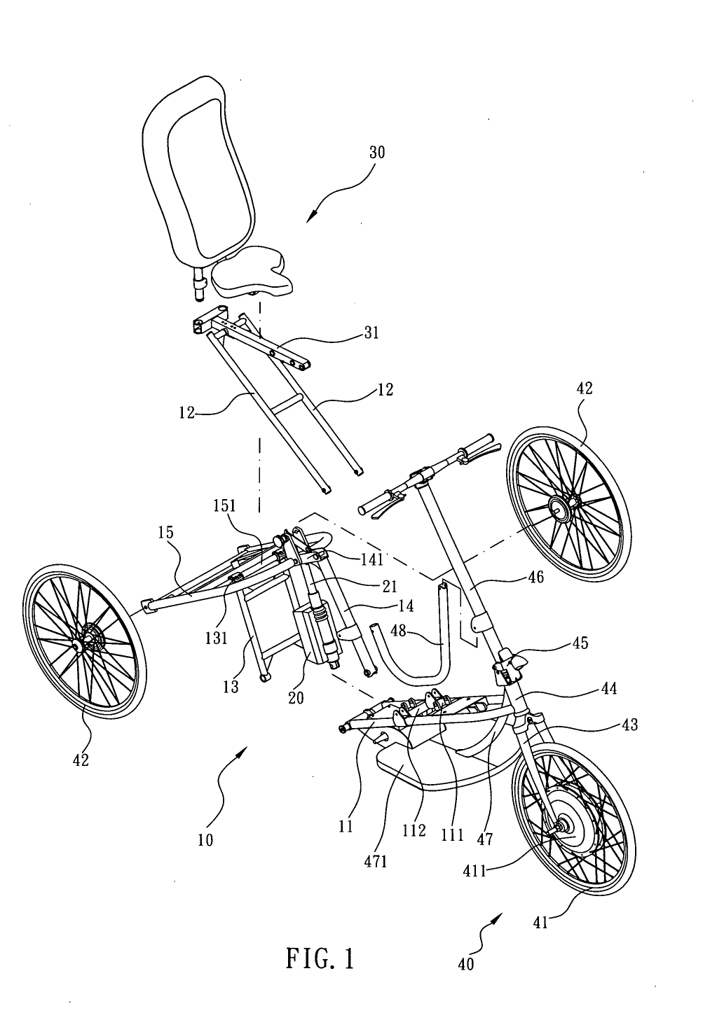

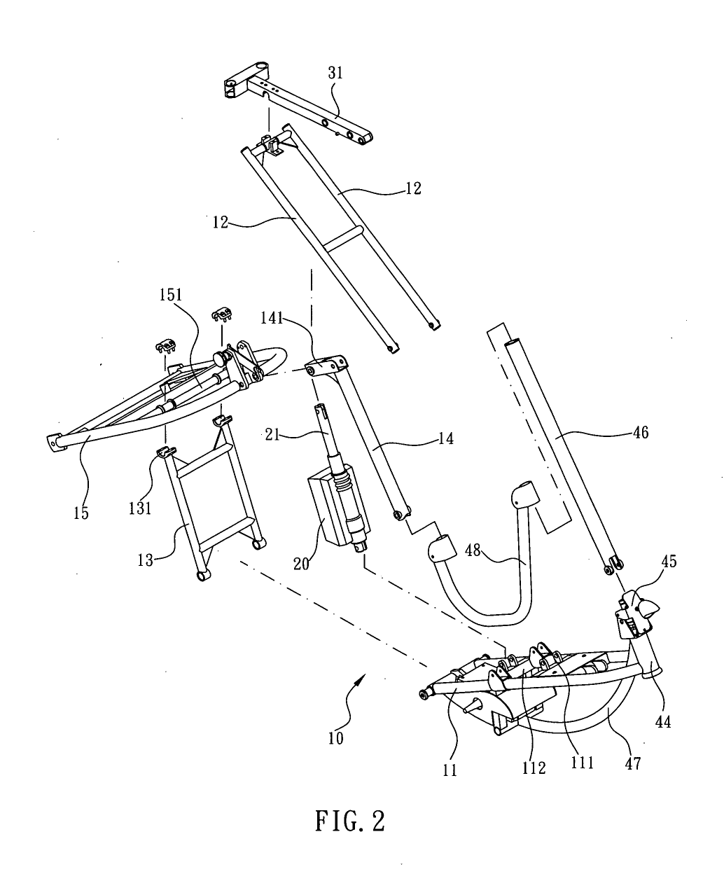

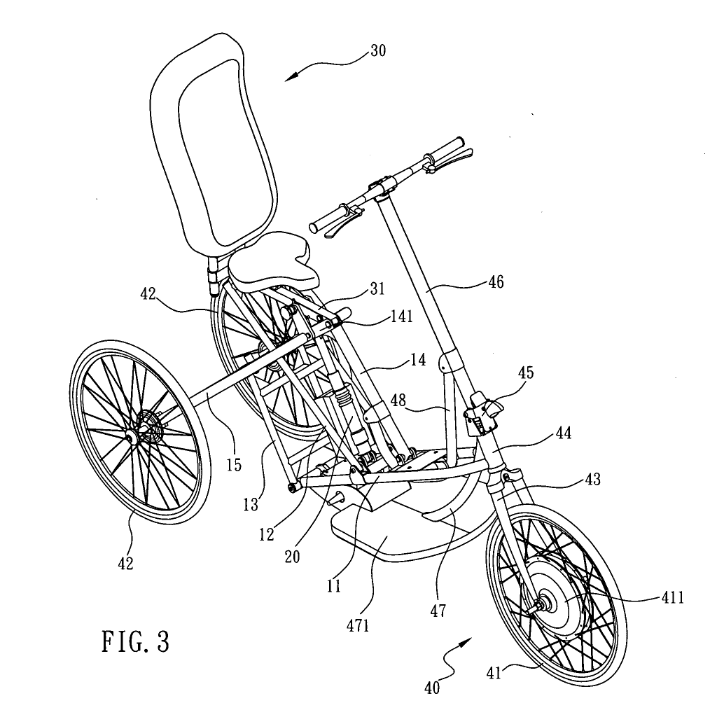

Please refer to FIG. 1 through FIG. 3 for light-duty vehicle with an adjustable wheelbase provided by the present invention. The light-duty vehicle may be a tricycle or an electric tricycle, which primarily comprises a linkage assembly 10, at least one power source 20, a seat 30, and a driving wheel set 40.

The linkage assembly 10 has at least one main rod 11. The main rod 11 is in a U-shape member to enclose therein a fixing seat 111 and a horizontal rod 112 successively from the front end to the rear end thereof. The main rod 11 is pivotally flanked by a pair of supporting rods 12 while the rear end of the main rod 11 is pivotally connected to a movable support 13. The movable support 13 has distally a first pivotal portion 131 opposite to the main rod 11. At least one movable rod 14 is pivotally connected to the fixing seat 111 and has distally a second pivotal portion 141 opposite to the fixing seat 111. The second pivotal portion 141 is pivotally connected to at least one adjusting rod 15 at an end opposite to the movable rod 14. The adjusting rod 15 is substantially U shaped with a holding bar 151 settled between two arms thereof, to which holding bar 151 the first pivotal portion 131 is pivotally connected.

The power source 20 may be a linear actuator that has an extendable shaft 21. The power source 20 has a bottom mounted on the horizontal rod 112, while the extendable shaft 21 and the adjusting rod 15 coaxially, pivotally connected to the second pivotal portion 141. The power source 20 is electrically coupled with a control switch (not shown) that is settled anywhere on the light-duty vehicle.

The seat 30 is underneath attached with at least one connecting rod 31, which is pivotally connected to the second pivotal portion 141 and corresponding to the movable rod 14 while an opposite end of the connecting rod 31 is pivotally connected to the supporting rod 12 opposite to the main rod 11.

The driving wheel set 40 includes at least one front wheel 41 and at least one rear wheel 42. In the present embodiment, the driving wheel set 40 is composed of a single said front wheel 41 and a pair of said rear wheels 42. In another embodiment, there may be two said front wheels 41 and one said rear wheel 42. The front wheel 41 is equipped with a motor device 411 for driving the front wheel 41 and the rear wheels 42 to move so that the vehicle of the present invention is an electric vehicle. The rear wheels 42 are connected to a rear end of the adjusting rod 15. A front fork 43 above the front wheel 41 is coupled with a fixed rod 44, which has a moveable joint 45 opposite to the front fork 43 for receiving a handle support 46. The main rod 11 has its front end attached to an inner side of the fixed rod 44 together with a pedal support 47 that flank supports a pair of pedal 471. An angle shifting rod 48 is pivotally connected between the handle support 46 and the movable rod 14.

Hereinafter, operation of the present invention is further explained.

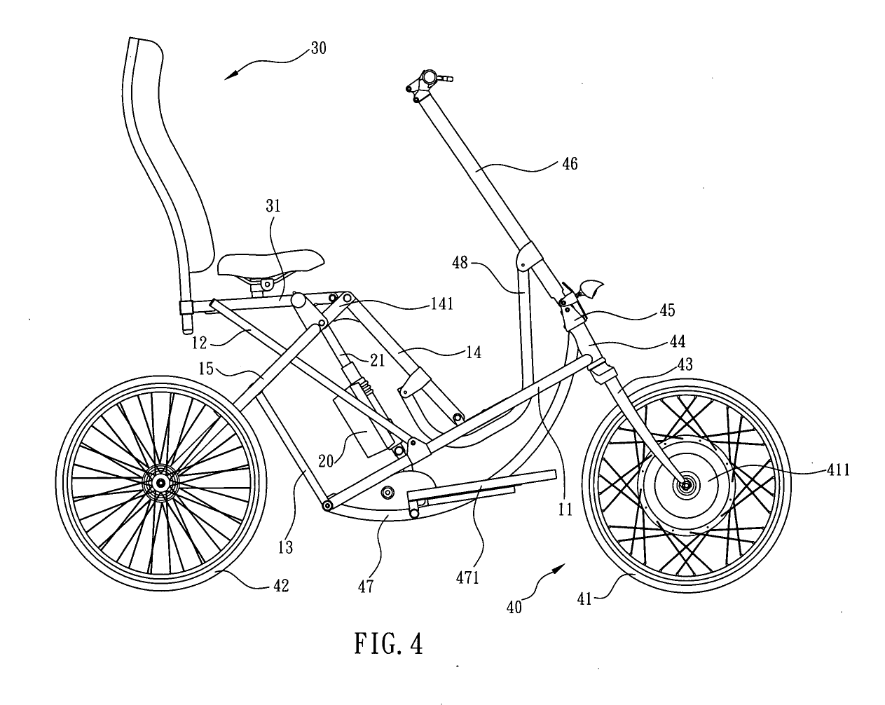

As shown in FIG. 4, the vehicle of the present invention is now in its sitting riding mode, where the main rod 11, the movable support 13, the movable rod 14 and the adjusting rod 15 interactively form a structure relatively close to a square and further connected to the rear wheel 42, the seat 30, the front wheel 41 and the handle support 46. The sitting riding mode is suitable for short-distance riding. Meantime, when a rider rides the vehicle in a sitting posture, his/her altitude is relatively high and beneficial to his/her visual scope as well as safety during riding, particularly when he/she is on a busy urban road.

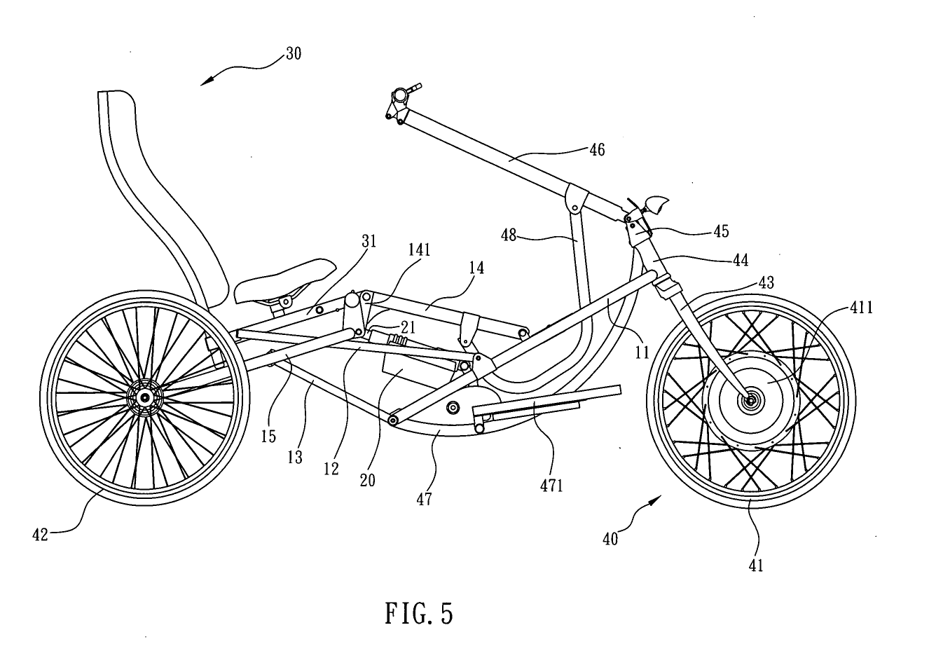

Alternatively, for a long-distance riding trip, the vehicle can be adjusted into a recumbent riding mode so as to recline the rider for enhanced riding comfort and reduced riding drag. To this end, operation of the control switch is performed manually to drive the power source 20 to retract the extendable shaft 21. Since the power source 20 is mounted on the horizontal rod 112 of the main rod 11, the retraction of the extendable shaft 21 thus draws the second pivotal portion 141 to move toward the main rod 11 and in turn makes the movable rod 14, the connecting rod 31, as well as the adjusting rod 15 to pivot with respect to each other. Finally, at the extreme retraction of the extendable shaft 21, the movable rod 14 and the connecting rod 31 become closer to the main rod 11 and more coaxial to each other as compared with their positions in the previously described sitting ridding mode, while the main rod 11, the movable support 13, the movable rod 14 and the adjusting rod 15 at this time form a structure relatively close to a horizontally longer parallelogram. Thereby, the distance between the front wheel 41 and the rear wheel 42 is increased and the seat 30 is lowered in altitude while inclined backward in position under the control of the supporting rod 12. Meantime, the angle shifting rod 48 is drawn by the movable rod 14 to make the handle support 46 to pivot against the moveable joint 45 toward the seat 30 for facilitating a rider's proper reach of the handle on the handle support 46, as shown in FIG. 5. The vehicle is thus set into its recumbent riding mode and allows a rider to ride it in a recumbent body posture.

Returning the disclosed light-duty vehicle from the recumbent riding mode to the sitting riding mode can be easily done by operating the control switch again to make the extendable shaft 21 extend and push upward the second pivotal portion 141. In response to such operation, the associated parts move in the way reverse to that stated above, so the seat 30 is returned to a higher altitude.

In the present embodiment, the vehicle is electrically powered and thus the motor device 411, the pedal support 47 and the pedals 471 are included. However, the present invention is not necessarily to be applied to an electric vehicle but any form of light-duty vehicles. In the case that the present invention is implemented in a human-powered bicycle or tricycle, the above parts can be replaced with corresponding parts for treadle operation by people skilled in the art.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A light-duty vehicle with an adjustable wheelbase, comprising:
a linkage assembly having:
at least one main rod;
a movable support having one end pivotally connected to an end of the main rod and having an opposite end formed with a first pivotal portion;
at least one movable rod having one end pivotally connected to a middle portion of the main rod, and having an opposite end formed with a second pivotal portion; and
at least one adjusting rod pivotally connected between the first pivotal portion and the second pivotal portion;
at least one power source connected between the main rod and the second pivotal portion;
a seat having therebeneath at least one connecting rod, which has one end coupled to the second pivotal portion through; and
a driving wheel set including at least one front wheel and at least one rear wheel between which the wheelbase is defined, wherein the rear wheel is rotatably connected to the adjusting rod, while an opposite end of the main rod is connected to a fixed rod, which is coupled to a front fork above the front wheel,
whereby operation of the power source moves the main rod and the second pivotal portion and in turn changes a position of the linkage assembly, so as to modify the wheelbase in length and the seat in altitude and posture.

2. The light-duty vehicle of claim 1, wherein a fixing seat is provided on the main rod for pivotally receiving the movable rod.

3. The light-duty vehicle of claim 1, wherein the main rod is substantially of a U shape enclosing therein a horizontal rod, and the power source has one end pivotally connected to the horizontal rod while having an opposite end together with the adjusting rod coaxially, pivotally connected to the second pivotal portion.

4. The light-duty vehicle of claim 1, wherein the adjusting rod is substantially of a U shape enclosing therein a holding bar for pivotally holding the movable support at the end opposite to the main rod.

5. The light-duty vehicle of claim 1, wherein the connecting rod is pivotally connected to the second pivotal portion, and the main rod is pivotally flanked by a pair of supporting rods that are pivotally connected to an opposite end of the connecting rod opposite to the second pivotal portion, so that the supporting rods support the seat and contribute to positional control of the seat through the connecting rod.

6. The light-duty vehicle of claim 1, wherein a moveable joint is provided at an end of the fixed rod opposite to the front fork for receiving a handle support, and an angle shifting rod is pivotally connected between the handle support and the movable rod for contributing to positional control of the handle support.

7. The light-duty vehicle of claim 1, wherein the power source is a linear actuator which has an extendable shaft for pushing or drawing the second pivotal portion with respect to the main rod, and in turn changing the position of the linkage assembly.

8. The light-duty vehicle of claim 1, wherein the power source is electrically connected to a control switch.

9. The light-duty vehicle of claim 1, wherein the light-duty vehicle is a tricycle having two said rear wheels rotatably connected to the adjusting rod.

10. The light-duty vehicle of claim 1, wherein a motor device is provided on the front wheel for driving the front wheel and the rear wheel to rotate.
